(19) United States
(12) Patent Application Publication
(10) Pub. No.: US 2013/0050077 A1
(43) Pub. Date: Feb. 28, 2013

(54) Terminal Including a Video Projector and a Screen, Having one Area that Enables Control of a Remote Pointer Projected by Said Video Projector

(71) Applicants: Vincent Auvray, Tonneville (FR); Jacques-Olivier Rebillon, Mutrecy (FR)

(72) Inventors: Vincent Auvray, Tonneville (FR); Jacques-Olivier Rebillon, Mutrecy (FR)

(73) Assignee: France Telecom, Paris (FR)

(21) Appl. No.: 13/696,543

(22) PCT Filed: May 3, 2011
(86) PCT No.: PCT/FR2011/050999

§ 371 Date: Nov. 6, 2012

(30) Foreign Application Priority Data
May 6, 2010 (FR) 1053530

(51) Int. Cl. G06F 3/033

(52) U.S. Cl. 345/157

(57) ABSTRACT

A terminal (10) that comprises: a screen (SCR) on which graphics objects can be displayed that are suitable for being selected by a pointer device (PTR); a video projector (30) suitable for projecting an image (IM) on a remote screen (RSCR); and means for incorporating a projected graphics object (RPTR) in the projected image (IM) and representative of a pointer referred to as a “remote” pointer. The screen of the terminal includes a zone (DZ), with interaction between the pointer device (PTR) and the zone (DZ) serving to control the remote pointer (RPTR) in the projected image (IM).

### BACKGROUND OF THE INVENTION

The present invention lies in the field of electronic terminals.

It applies in particular to mobile telephony terminals and to personal digital assistants (PDAs).

Recently, multimedia terminals have begun to incorporate video projectors, often referred to as “pico projectors”. In particular, there is the terminal from the supplier Samsung (registered trademark) named “Android Smart Phone Projector i8520”.

In the present state of the art, the video projector does no more than project an identical replica of the image displayed on the screen of the terminal. The man/machine interface of such terminals is not satisfactory for controlling such video projectors.

### OBJECT AND SUMMARY OF THE INVENTION

The present invention proposes a terminal that does not present the drawbacks of prior art terminals.

More precisely, in a first aspect, the invention provides a terminal comprising:
a screen on which graphics objects can be displayed that are suitable for being selected by a pointer device; and
a video projector suitable for projecting an image on a remote screen.

The terminal includes:
means for incorporating a projected graphics object in the projected image and representative of a pointer referred to as a “remote” pointer; and
its screen includes a zone for interaction between the pointer device and that zone, enabling the remote pointer in the projected image to be controlled.

In a particular embodiment of the invention, the terminal of the invention may be a mobile terminal. For example it may be a mobile terminal or a PDA.

Thus, and in general, the invention seeks to define a man/machine interface zone for the terminal that is suitable for use in controlling the pointer projected in the image, which pointer is used for controlling the man/machine interface (MMI) of the video projector. Thus, when the pointer device lies outside the zone (DZ) the interactions between the pointer device and the screen are managed in the same manner as when the video projector (30) is not active.

In a particular embodiment of the invention, the terminal includes a touch screen, and the pointer device may be constituted by a user's finger or a stylus compatible with such a screen.

In such an embodiment, the zone for controlling the remote pointer in the projected image may be a touch pad of the type conventionally to be found on laptop computers.

In another embodiment in which the terminal does not have a touch pad, the above-mentioned zone may be a display zone of the screen, with the pointer device, e.g. a scroll wheel, controlling the video projector only when it is to be found in said display zone.

In an embodiment of the invention, the display zone may contain virtual buttons that, on being activated by the pointer device of the terminal, serve to select the projected graphics object in the video projector image that is identified by the remote pointer.

In an embodiment of the invention, movement of the pointer device in the zone gives rise to proportional movement of the remote pointer in the projected image. By way of example, the proportionality factor may be the ratio between the resolution of the terminal screen and the resolution of the video projector.

In a particular embodiment of the invention, this proportionality factor may be modified via the man/machine interface of the terminal or via the man/machine interface of the video projector.

In another embodiment, the position of the remote pointer in the projected image depends on the position of the pointer device in the zone. For example, when the pointer of the pointer device is located in the top left corner of the zone, the remote pointer takes up a position in the top left corner of the projected image.

In an embodiment of the invention, the terminal has means for defining and for projecting a graphics interface specific to the video projector.

This embodiment thus makes it possible to provide the user with a context close to that which the user finds on a computer, e.g. of the virtual desk top type. The virtual desk top may for example be of the same type as the virtual desk tops used in the Windows XP, MacOSX, or Linu (registered trademarks) operating systems.

By way of example, the graphics interface includes drop-down menus serving to switch the video projector on or off and giving access to functions of the video projector.

Advantageously, this graphics interface specific to the video projector may be controlled by means of a pointer device of the terminal when it interacts with the above-mentioned zone of the terminal. This embodiment of the invention provides the user with a natural graphics interface: the user can move the remote pointer, making use of it to select objects and to drag them in the projected image.

In a particular embodiment of the invention, certain applications of the terminal are suitable for formatting the content for projection by the video projector so as to take account of at least one characteristic of the video projector, e.g. its resolution or the number of colors it can display.

These characteristics make it possible to take advantage of the present and future characteristics of video projectors in terms of high resolution display, video decoding, or color management, given that the screen of the terminal, in particular a mobile terminal, might offer characteristics that are more limited in terms of the resolution or the number of colors it can handle.

In accordance with the invention, the image projected by the video projector may be all or part of the image displayed on the screen of the terminal.

It may also be an image that is not displayed simultaneously on the screen of the terminal.

By way of example, it is possible to use the man/machine interface of the video projector for playing back a video without the video appearing on the screen of the terminal.

The invention also provides a method of controlling a pointer in an image projected by a video projector incorporated in a terminal having a screen on which graphics objects can be displayed that are suitable for being selected by a pointer device. This method comprises:
a step of incorporating a projected graphics object in the projected image, the object representing a so-called “remote” pointer;
a step of detecting an interaction between the pointer device and the zone of the screen; and
a step of controlling said remote pointer in the projected image as a function of this interaction.

In a particular implementation, the various steps of the control method are determined by computer program instructions.

Consequently, the invention also provides a computer program on a data medium, the program being suitable for being executed by a computer, the program including instructions adapted to implementing steps of the control method as mentioned above.

The program may use any programming language, and may be in the form of source code, object code, or code intermediate between source code and object code, such as in a partially compiled form, or in any other desirable form.

The invention also provides a computer readable data medium having instructions of a computer program as mentioned above.

The data medium may be any entity or device capable of storing the program. For example, the medium may comprise storage means, such as a read only memory (ROM), e.g. a compact disk (CD) ROM, or a microelectronic circuit ROM, or indeed magnetic recording means, e.g. a floppy disk or a hard disk.

Furthermore, the data medium may be a transmissible medium such as an electrical or optical signal, suitable for being conveyed via an electrical or optical cable, by radio, or by other means. The program of the invention may in particular be downloaded from an Internet type network.

Alternatively, the data medium may be an integrated circuit in which the program is incorporated, the circuit being adapted to execute or to be used in the execution of the method in question.

### BRIEF DESCRIPTION OF THE DRAWINGS

Other characteristics and advantages of the present invention appear from the following description made with reference to the accompanying drawings that show an embodiment having no limiting character. In the figures:

FIG. 1 shows a terminal in accordance with a particular embodiment of the invention;

FIG. 2 shows the hardware architecture of the FIG. 1 terminal;

FIG. 3 shows an example of how the FIG. 1 terminal can be used; and

FIG. 4 is a flow chart showing the main steps of a control method in accordance with a particular implementation of the invention.

### DETAILED DESCRIPTION OF THE INVENTION

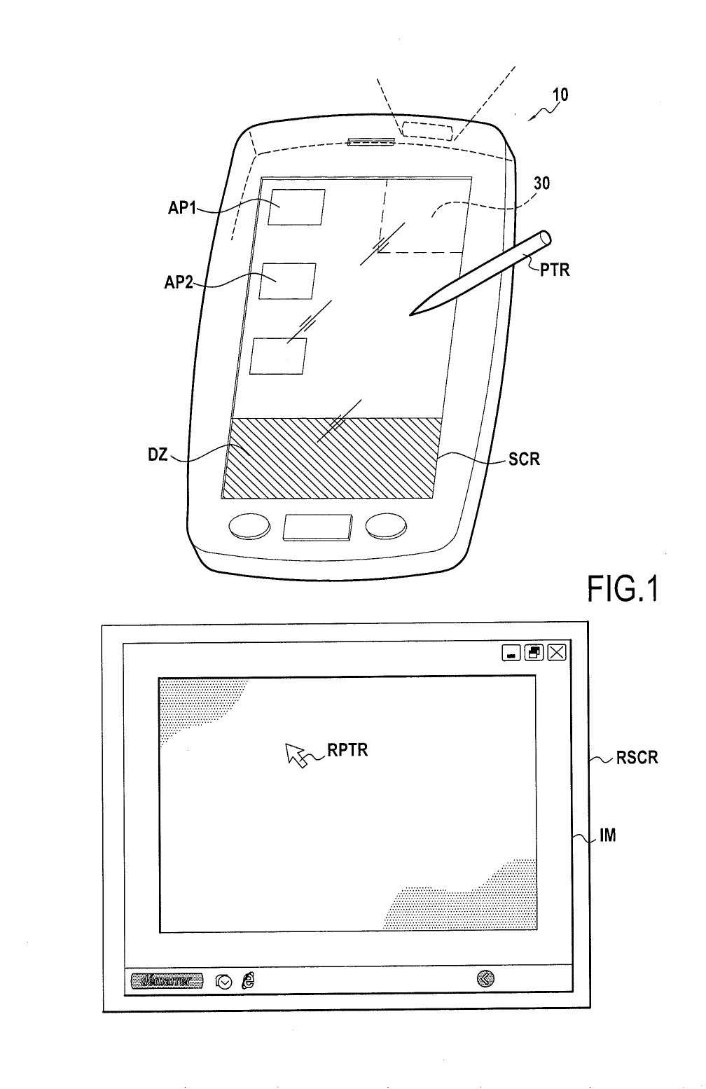

FIG. 1 shows a terminal 10 in accordance with the invention. In the embodiment described herein, the terminal is a mobile terminal. It has a touch screen SCR that may be used either with a finger, or with a pointer device PTR.

Various graphics objects are displayed on the screen SCR to represent applications AP1, AP2, these applications being selectable by means of the finger or the pointer device PTR.

The terminal 10 incorporates a video projector 30 suitable for projecting an image IM on a remote screen RSCR, which image includes a projected graphics object RPTR representing a remote pointer.

In accordance with the invention, the screen SCR includes a zone DZ, and interaction between the pointer device PTR and said zone enables the remote pointer RPTR to be controlled in the projected image IM.

In the embodiment described herein, when the video projector 30 is off, the zone DZ acst as a normal display zone of the screen SCR of the terminal 10. It is reserved for controlling the video projector 30 only when it is in use.

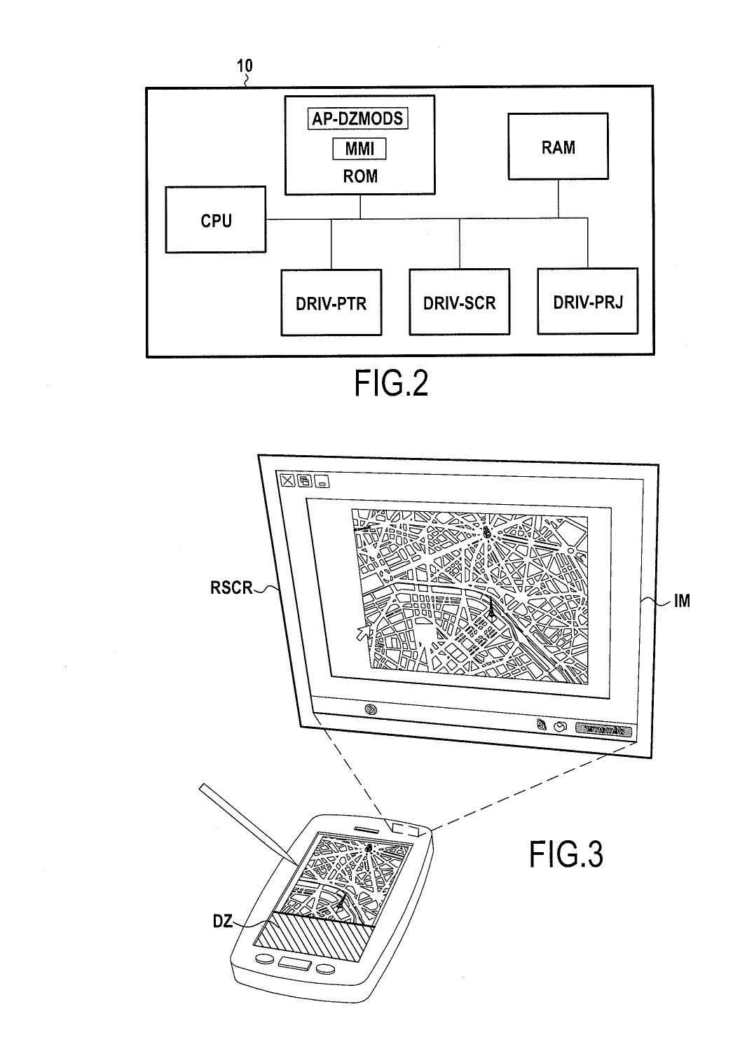

In the embodiment described herein, the terminal 10 has the conventional architecture of a computer, as shown diagrammatically in FIG. 2.

More precisely, the terminal 10 comprises a processor CPU, a ROM, and a random access memory (RAM).

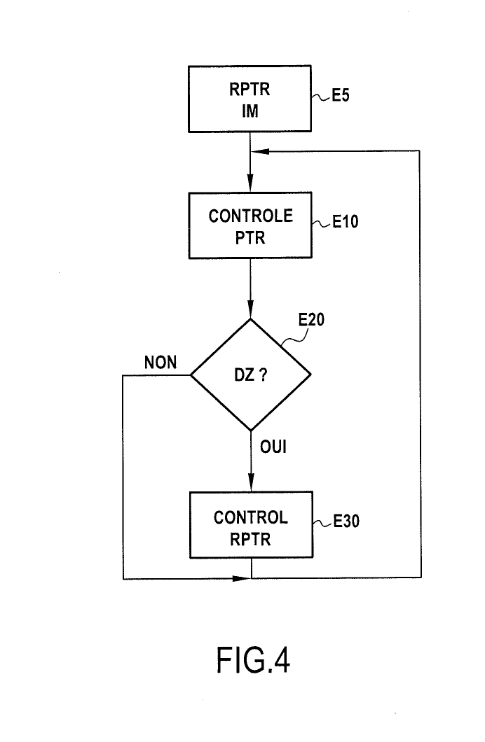

The ROM constitutes a recording medium in the meaning of the invention. It stores a computer program having instructions for executing steps of a control method of the invention, as described below with reference to FIG. 4.

In the embodiment described herein, the ROM also includes a computer program AP-DZMODS suitable for determining whether the video projector is in use or not. For example, the terminal 10 may have a menu or an icon enabling the user to switch the video projector 30 on and off, which events are managed by the program AP-DZMODS.

The terminal 10 also comprises:
a software module (or driver) DRIV-PTR for managing the pointer device PTR;
a software module DRIV-SCR for managing the display on the local screen SCR; and
a software module DRIV-PRJ for managing the video projector 30.

When the video projector 30 is inactive, the software module DRIV-PTR operates in conventional manner. It manages interactions between the pointer device PTR and the screen SCR over the entire working surface of the screen SCR. It takes account in particular of events of the following types: pointer press, pointer release, click, double click, entry into the control zone, exit from the control zone, . . . .

When the video projector 30 is active, the software module DRIV-PTR continues to operate in the same manner so long as the pointer device PTR lies outside the zone DZ.

When the pointer device is in the zone DZ, then the software module DRIV-PTR reserves the zone DZ for controlling the remote pointer RPTR, and this zone is no longer used for displaying the local applications of the terminal 10. The remote pointer RPTR is controlled by the software module DRIV-PTR in similar manner: events of the above-mentioned type (pointer press, pointer release, click, double click, entry into the control zone, exit from the control zone, . . . ) are detected, having the effect of controlling the remote pointer RPTR in the image IM. In the embodiment described herein, the ROM includes a computer program MMI defining the graphics interface specific to the video projector 30.

In the embodiment described herein, this graphics interface MMI reproduces a virtual desk top enabling the video projector to be controlled, as shown in FIG. 1.

This virtual desk top includes in particular a virtual button enabling the video projector 30 to be switched off, enabling settings functions of the video projector 30 to be selected, or giving access to a file system containing multimedia files that may be projected by the video projector 30.

As described above, graphics objects in the projected image IM on the virtual desk top are selected by moving the remote pointer RPTR to the menu in question, with this pointer being moved by moving the pointer device PTR in the zone DZ of the terminal 10.

In the embodiment described herein, certain applications of the terminal 10 include means for formatting the content projected by the video projector 30, with this formatting taking account of one or more characteristics of the video projector.

For example, FIG. 3 shows the graphics interface of a position finding application, firstly on the screen of the terminal 10, and secondly the image IM as projected by the video projector.

In this example, formatting consists in redimensioning the projected content to take account of the video projector 30 having resolution that is greater than the resolution of the screen of the terminal 10.

Thus, only a portion of the projected image IM is displayed on the screen of the terminal 10.

Although not visible in FIG. 3, the projected image IM has more colors than the image displayed on the screen SCR of the terminal 10.

FIG. 4 shows the main steps of a method of controlling the pointer RPTR in accordance with a particular implementation of the invention.

This method has a step E5 in which the graphics object RPTR representative of the remote pointer is incorporated in the projected image IM.

When interacting with the screen of said terminal 10, the pointer device PTR is controlled during a general step E10 by the software module DRIV-PTR.

At all times, this software module verifies whether the pointer device PTR does or does not lie in the zone DZ (test E20).

If it does, then the software module DRIV-PTR causes the remote pointer RPTR to move in the projected image IM, as a function of the interaction between the pointer device PTR and the zone DZ. More precisely, a movement of the pointer device PTR leads to a proportional movement of the remote pointer RPTR in the image, and a double click on the zone DZ selects the graphics object in the image IM identified by the remote pointer RPTR.

The purpose of test step E20 is thus to determine whether the pointer device PTR does or does not lie in the zone DZ such that when the pointer device PTR is in the zone DZ, the interaction between the pointer device PTR and said zone DZ serves to control said remote pointer RPTR in the projected image IM, whereas when the pointer device PTR is outside the zone DZ, interactions between the pointer device PTR and the screen SCR are managed as though the video projector 30 were inactive. If the pointer device PTR is indeed in the zone DZ, a step E30 controls said remote pointer RPTR in said projected image IM as a function of said interaction.

1. A terminal comprising:
a screen on which graphics objects can be displayed that are suitable for being selected by a pointer device;
a video projector suitable for projecting an image on a remote screen; and
means for incorporating, in said projected image a projected graphics object representative of a pointer referred to as a “remote” pointer;
wherein said screen includes a zone, for the interaction between said pointer device and said zone enabling said remote pointer in said projected image to be controlled.

2. The terminal according to claim 1, wherein movement of said pointer device in said zone gives rise to proportional movement of said remote pointer in said projected image.

3. The terminal according to claim 1, wherein the position of said remote pointer in said projected image depends on the position of said pointer device in said zone.

4. The terminal according to claim 1, wherein a predetermined action of said pointer device in said zone enables a projected graphics objects in said projected image and identified by said remote pointer to be selected.

5. The terminal according to claim 1, including means for defining and projecting a graphics interface specific to said video projector, said graphics interface including at least one graphics object, a predetermined interaction between said pointer device and said zone enabling the projected graphics object of said graphics interface that is identified by said remote pointer to be controlled.

6. The terminal according to claim 1, it includes comprising at least one application, said application including means for formatting a content for projection by said video projector while taking account of at least one characteristic of said video projector.

7. The terminal according to claim 6, wherein said characteristic is selected from the resolution and the number of colors that can be displayed by said video projector.

8. A method of controlling a pointer in an image projected by a video projector incorporated in a terminal having a screen on which graphics objects can be displayed that are suitable for being selected by a pointer device, the method comprising:
a step of incorporating a projected graphics object in said projected image, the object representing a so-called “remote” pointer;
a step of detecting an interaction between the pointer device and the zone of said screen; and
a step of controlling said remote pointer in said projected image as a function of said interaction.

9. A computer program including instructions for executing steps of the control method of claim 8 when said program is executed by a computer.

10. A computer readable recording medium having recorded thereon a computer program including instructions for executing the steps of the control method of claim 8.
